(19) United States
(12) Patent Application Publication
(10) Pub. No.: US 2026/0241486 A1
(43) Pub. Date: Aug. 20, 2026

(54) WELDING DEVICE AND MANUFACTURING METHOD FOR ELECTRICAL ENERGY STORAGE DEVICE

(71) Applicant: Prime Planet Energy & Solutions, Inc., Tokyo (JP)

(72) Inventors: Hirokazu OKAMOTO, Takasago-shi (JP); Kazuki TAMURA, Takasago-shi, Hyogo-ken (JP); Haruhiko YAMAMOTO, Nissin-shi (JP); Kentaro ABE, Minamiawaji-shi (JP)

(21) Appl. No.: 19/540,788

(22) Filed: Feb. 16, 2026

(30) Foreign Application Priority Data
Feb. 19, 2025 (JP) 2025-025305

(51) Int. Cl. B23K 26/082; B23K 26/14; B23K 31/12

(52) U.S. Cl. CPC B23K 26/082; B23K 26/1476; B23K 31/125

(57) ABSTRACT

A welding device includes a laser irradiation part that causes laser to travel along a laser irradiation region corresponding to a boundary between a case main body and a sealing plate, and an inert gas supply part that supplies an inert gas toward the laser irradiation region. The inert gas supply part includes a chamber including an internal space, a supply pipe supplying the inert gas to the internal space, a slit-shaped nozzle communicating with the supply pipe through the internal space and extends along one side of the laser irradiation region, and a rectifying member corresponding to a porous body accommodated in the internal space to partition between the supply pipe and the nozzle. Thus, the variation in flow rate of the inert gas in an extending direction of the nozzle can be solved and the oxygen concentration around the laser irradiation region can be suitably reduced.

### CROSS REFERENCE TO RELATED APPLICATIONS

This application claims the benefit of priority to Japanese Patent Application No. 2025-025305 filed on Feb. 19, 2025. The entire contents of this application are incorporated herein by reference.

### BACKGROUND

### 1. Technical Field

The art disclosed herein relates to a welding device and a manufacturing method for an electrical energy storage device.

### 2. Description of the Related Art

A case of an electrical energy storage device is manufactured by mounting a sealing plate on an opening part of a case main body and welding the case main body and the sealing plate. For example, Japanese Patent Application Publication No. 2013-197034 discloses a laser welding device that welds a case and a lid plate of a secondary battery. This laser welding device includes a laser irradiation part, an inert gas supply pipe for jetting an inert gas, an inert gas output port for outputting the inert gas, and a vacuum pump connected to the inert gas output port. The inert gas output port is disposed on a side opposite to a portion where the diffusion of a defective product is desirably avoided. In this laser welding device, the defective product generated due to the laser welding, such as spatter or fume, is discharged following the flow of the inert gas.

In addition, a laser welding device according to Japanese Patent Application Publication No. 2019-130556 includes a suction jig that is brought into contact with a side surface of a case main body. This suction jig includes a first suction port that opens at a position with the height that is lower than or equal to a lid along the side surface of the case main body, a second suction port that is disposed above the first suction port and opens up to a position with the height that is higher than the lid, a first connector that is provided in a first suction path communicating with the first suction port, and a second connector that is provided in a second suction path communicating with the second suction port. Moreover, a suction device of this laser welding device is connected to the first connector and the second connector. By such a laser welding device, the spatter and fume can be discharged efficiently.

### SUMMARY

Incidentally, in the welding between the case main body and the sealing plate, it is preferable to make the oxygen concentration around a laser irradiation region low by jetting the inert gas (such as nitrogen gas) to the laser irradiation region. This makes it possible to form a welding part of high quality in which the oxidation is suppressed. In the actual manufacturing site, however, jetting the inert gas may fail to reduce the oxygen concentration around the laser irradiation region sufficiently, in which case the oxidation of the welding part may occur.

A welding device disclosed herein is used to weld a case main body with an substantially cuboid shape that includes an opening part on at least one surface, and a sealing plate with an substantially rectangular shape that closes the opening part. This welding device includes a laser irradiation part that causes laser to travel along a laser irradiation region corresponding to a boundary between the case main body and the sealing plate; and an inert gas supply part that supplies an inert gas toward the laser irradiation region. This inert gas supply part includes: a chamber that includes an internal space, a supply pipe that supplies the inert gas to the internal space of the chamber, a slit-shaped nozzle communicating with the supply pipe through the internal space and extending along at least one side of the laser irradiation region, and a rectifying member being a porous body that is accommodated in the internal space to partition between the supply pipe and the nozzle.

As a result of the present inventors' examinations, it has been found out that a turbulent flow may be caused in the inert gas jetted toward the laser irradiation region in the conventional welding device. In this case, the ambient air is caught in the inert gas, which may result in that the oxygen concentration around the laser irradiation region does not decrease sufficiently. In contrast to this, the welding device disclosed herein jets the inert gas from the slit-shaped nozzle extending along one side of the laser irradiation region. Furthermore, the inert gas before being supplied to the nozzle passes the rectifying member, which is a porous body. Thus, the slit-shaped nozzle can jet the inert gas with the flow rate in an extending direction of the nozzle homogenized. As a result, the air being caught by the turbulent flow can be prevented. Accordingly, by the welding device disclosed herein, the oxygen concentration around the laser irradiation region is reduced sufficiently; thus, the welding part of the high quality in which the oxidation is suppressed can be formed.

### BRIEF DESCRIPTION OF THE DRAWINGS

FIG. 1 is a perspective view schematically illustrating one example of an electrical energy storage device manufactured in a first embodiment;

FIG. 2 is a perspective view schematically illustrating a welding device according to the first embodiment;

FIG. 3 is a plan view of the welding device illustrated in FIG. 2;

FIG. 4 is a cross-sectional arrow view taken along line IV-IV in FIG. 3;

FIG. 5 is a perspective view schematically illustrating an assembling step of a manufacturing method according to the first embodiment;

FIG. 6 is a cross-sectional view schematically illustrating a welding device according to another embodiment;

FIG. 7 is a perspective view schematically illustrating one example of an electrical energy storage device manufactured in another embodiment;

FIG. 8 is a graph showing measurement results of oxygen concentration distributions in Test Examples;

FIG. 9 is an external appearance photograph of a welding part formed in Test Example 1; and

FIG. 10 is an external appearance photograph of a welding part formed in Test Example 2.

### DETAILED DESCRIPTION

Embodiments of the art disclosed herein will be described below with reference to the drawings. Note that matters other than matters particularly mentioned in the present specification, and necessary for the implementation of the art disclosed herein (for example, the internal structure of an electrical energy storage device and the like) can be grasped as design matters of those skilled in the art based on the conventional art in the relevant field. The art disclosed herein can be implemented on the basis of the disclosure of the present specification and common technical knowledge in the relevant field.

### First Embodiment

A first embodiment of the art disclosed herein is described below.

### A. Electrical Energy Storage Device

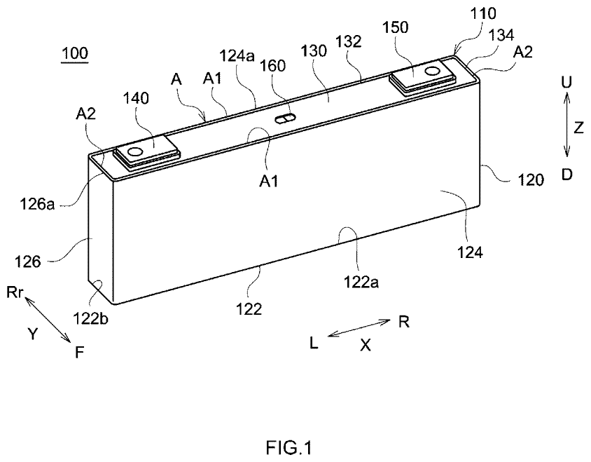

In this specification, first, a structure of an electrical energy storage device manufactured in this embodiment is described. FIG. 1 is a perspective view schematically illustrating one example of the electrical energy storage device manufactured in the first embodiment. Note that reference signs X, Y, and Z in each drawing used in this specification respectively denote a width direction, a depth direction, and a height direction. Moreover, reference signs F, Rr, U, D, L, and R respectively denote front, rear, up, down, left, and right. These directions, however, are defined for the convenience of the explanation, and are not intended to limit the direction in which the electrical energy storage device or a welding device is disposed, for example.

Note that the term “electrical energy storage device” in this specification widely encompasses devices capable of being charged and discharged reversibly (such as secondary batteries and capacitors). Examples of the secondary batteries include a lithium ion secondary battery, a lithium polymer battery, a nickel hydrogen battery, and the like. Examples of the capacitors include an electric double layer capacitor, a lithium ion capacitor, and the like.

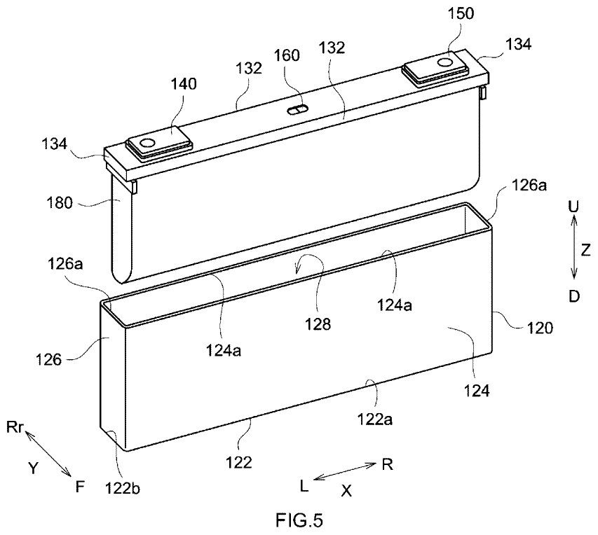

An electrical energy storage device 100 illustrated in FIG. 1 includes a case 110 that accommodates an electrode body 180 (see FIG. 5). A structure and a material of the electrode body 180 can be changed as appropriate in accordance with the kind of the electrical energy storage device 100, and since such changes do not limit the art disclosed herein, the detailed description is omitted. On the other hand, the case 110 is a flat and square (that is, substantially cuboid) container. This case 110 is formed of aluminum, an aluminum alloy, a stainless alloy, or the like. In addition, the case 110 includes a case main body 120 and a sealing plate 130.

The case main body 120 illustrated in FIG. 1 is a container with an substantially cuboid shape including an opening part 128 (see FIG. 5) on one surface (here, a surface on an upper side U). Specifically, the case main body 120 includes a bottom wall 122 with an substantially rectangular shape extending in the width direction X, a pair of first side walls 124 extending to the upper side U from long sides 122a of the bottom wall 122, and a pair of second side walls 126 extending to the upper side U from short sides 122b of the bottom wall 122. The opening part 128 of the case main body 120 is an opening part with an substantially rectangular shape surrounded by upper ends 124a of the first side walls 124 and upper ends 126a of the second side walls 126 (see FIG. 5).

The sealing plate 130 is a member with an substantially rectangular shape that closes the opening part 128 of the case main body 120. Specifically, the sealing plate 130 includes a pair of long sides 132 extending in the width direction X and a pair of short sides 134 extending in the depth direction Y. In a case where the sealing plate 130 is mounted on the opening part 128 of the case main body 120, the long sides 132 of the sealing plate 130 are disposed along the upper ends 124a of the first side walls 124 of the case main body 120. On the other hand, the short sides 134 of the sealing plate 130 are disposed along the upper ends 126a of the second side walls 126 of the case main body 120.

Here, a boundary between the case main body 120 and the sealing plate 130 corresponds to a region to be irradiated with laser L (laser irradiation region A) in a welding process to be described below. As illustrated in FIG. 1, the laser irradiation region A in this embodiment includes first regions A1 and second regions A2. The first region A1 is a boundary between the long side 132 of the sealing plate 130 and the upper end 124a of the first side wall 124. The first regions A1 are a pair of linear regions extending along the width direction X. On the other hand, the second region A2 is a boundary between the short side 134 of the sealing plate 130 and the upper end 126a of the second side wall 126. The second regions A2 are a pair of linear regions extending along the depth direction Y. Both end parts of the first regions A1 in the width direction X are connected to both end parts of the second regions A2 in the depth direction Y. Thus, along the boundary between the case main body 120 and the sealing plate 130, the laser irradiation region A with an substantially rectangular frame shape is formed. In this case, the first region A1 where the long side of the case main body 120 and the long side of the sealing plate 130 face each other is longer than the second region A2 where the short side of the case main body 120 and the short side of the sealing plate 130 face each other.

The electrical energy storage device 100 illustrated in FIG. 1 includes a positive electrode terminal 140, a negative electrode terminal 150, and a gas discharge valve 160. The positive electrode terminal 140 and the negative electrode terminal 150 are conductive members to be connected to the electrode body 180 (see FIG. 5) inside the case 110. The gas discharge valve 160 is a thin part that is fractured with priority when the internal pressure of the case 110 rises. These members do not limit the art disclosed herein and a conventionally known structure can be employed without particular limitations; thus, the detailed description is omitted.

### B. Welding Device

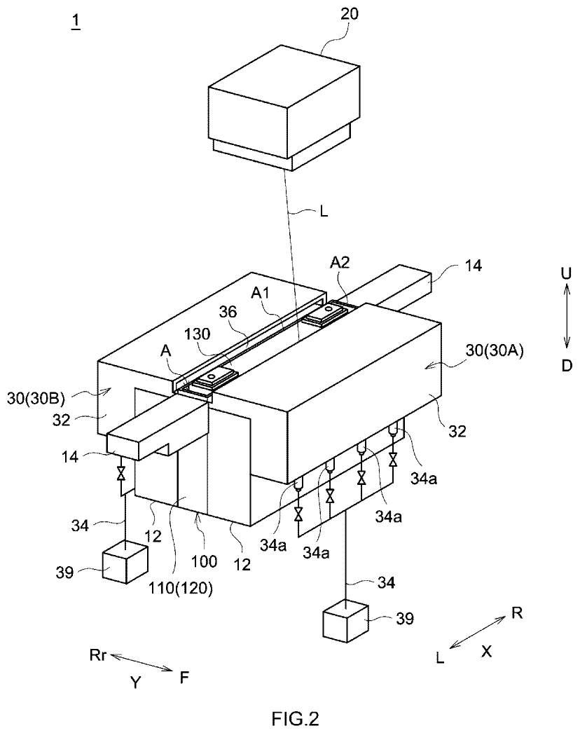

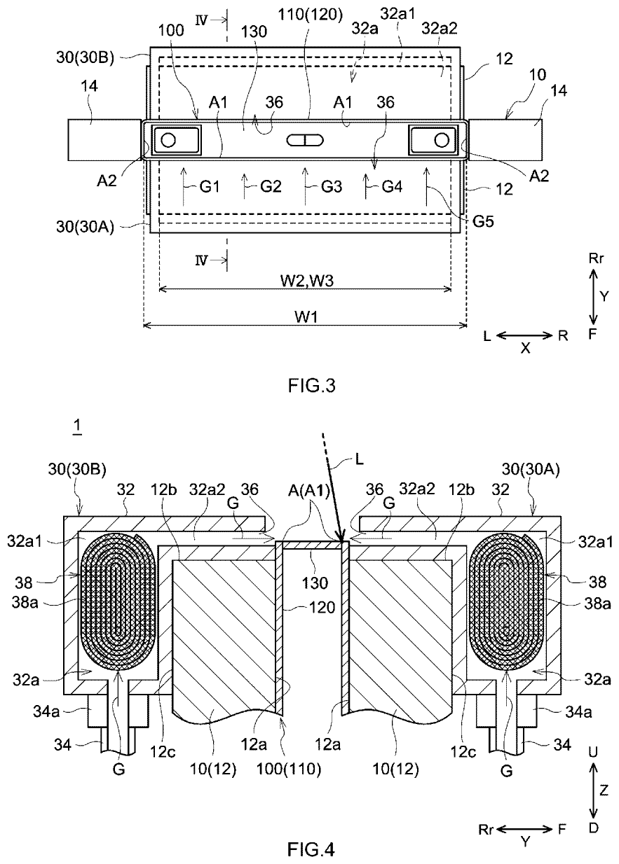

Next, a welding device 1 according to the first embodiment is described. FIG. 2 is a perspective view schematically illustrating the welding device according to the first embodiment. FIG. 3 is a plan view of the welding device illustrated in FIG. 2. FIG. 4 is a cross-sectional arrow view taken along line IV-IV in FIG. 3. Note that, in FIG. 4, the contents of the case 110 (the electrode body 180 and the like) are not illustrated for the convenience of the explanation.

As illustrated in FIG. 2 to FIG. 4, the welding device 1 according to this embodiment includes a laser irradiation part 20 and an inert gas supply part 30. In addition, this welding device 1 includes a positioning part 10. Each structure will hereinafter be described.

### 1. Positioning Part 10

The positioning part 10 is a member that fixes the case main body 120. As illustrated in FIG. 3, the positioning part 10 includes a pair of first clamps 12 facing each other with the case main body 120 held therebetween in the depth direction Y, and a pair of second clamps 14 facing each other with the case main body 120 held therebetween in the width direction X. The first clamp 12 includes a first contact surface 12a that is in contact with the first side wall 124 of the case main body 120. When the case main body 120 is held between the pair of first clamps 12, the movement of the case main body 120 in the depth direction Y is restricted. On the other hand, the second clamp 14 includes a second contact surface 14a that is in contact with the second side wall 126 of the case main body 120. When the case main body 120 is held between the pair of second clamps 14, the movement of the case main body 120 in the width direction X is restricted. Thus, the displacement during the laser L irradiation can be prevented.

### 2. Laser Irradiation Part 20

The laser irradiation part 20 is a device that causes the laser L to travel along the laser irradiation region A, which is the boundary between the case main body 120 and the sealing plate 130. As illustrated in FIG. 2, the laser irradiation part 20 is disposed on the upper side U relative to the positioning part 10 and the inert gas supply part 30. Although the detailed illustration is omitted, the laser irradiation part 20 includes an oscillator that generates the laser L, an irradiation port that delivers the laser L, and an optical path configuration member (such as a mirror or an optical fiber) that guides the laser L from the oscillator to the irradiation port. Then, the laser irradiation part 20 irradiates the laser irradiation region A of the electrical energy storage device 100 with the laser L. At this time, the laser irradiation part 20 adjusts the direction of the irradiation port so that the laser L travels along the laser irradiation region A. Thus, a welding part connecting between the case main body 120 and the sealing plate 130 is formed.

### 3. Inert Gas Supply Part 30

The inert gas supply part 30 is a device that supplies an inert gas G toward the laser irradiation region A. As illustrated in FIG. 2 to FIG. 4, the welding device 1 according to this embodiment includes a pair of inert gas supply parts 30A and 30B that face each other with the electrical energy storage device 100 held therebetween in the depth direction Y. This pair of inert gas supply parts 30A and 30B jet the inert gas G from both outer sides to the inside in the depth direction Y (see FIG. 4). Thus, the oxygen concentration around the laser irradiation region A (a space on the upper side U of the laser irradiation region A) can be reduced.

In addition, the inert gas supply part 30 in this embodiment is attached to the positioning part 10. The pair of inert gas supply parts 30A and 30B are attached to the first clamps 12 of the positioning part 10, and this structure will be described in detail below. Thus, a jetting position (nozzle 36) of the inert gas G can be fixed to a vicinity of the laser irradiation region A. As a result, the oxygen concentration around the laser irradiation region A can be reduced more suitably. Moreover, integrating the inert gas supply part 30 and the positioning part 10 can contribute to the reductions of the number of components and the size of the welding device 1, for example.

The detailed structure of the inert gas supply parts 30A and 30B is described below. Note that the welding device 1 according to this embodiment includes the pair of inert gas supply parts 30A and 30B that face each other with the electrical energy storage device 100 held therebetween in the depth direction Y as described above. This pair of inert gas supply parts 30A and 30B are configured to have a line-symmetric structure with the electrical energy storage device 100 held therebetween as illustrated in FIG. 4. Therefore, the structure of the inert gas supply part 30A on a front side F will be mainly described below. The inert gas supply part 30 according to this embodiment includes a chamber 32, a supply pipe 34, the nozzle 36, and a rectifying member 38.

### (1) Chamber 32

The chamber 32 is a housing including an internal space 32a. As illustrated in FIG. 4, the chamber 32 is attached to the positioning part 10; specifically, the chamber 32 is attached so as to cover an upper surface 12b and a rear surface 12c of the first clamp 12. Inside this chamber 32, the internal space 32a serving as a flow channel of the inert gas G is provided. As illustrated in FIG. 4, the internal space 32a is a space with an L-shaped cross section including a first flow channel 32a1 and a second flow channel 32a2. The first flow channel 32al is a flow channel extending along the height direction Z. On the other hand, the second flow channel 32a2 is a flow channel extending along the depth direction Y. Then, in the inert gas supply part 30A on the front side F, an end part of the first flow channel 32al on the upper side U and an end part of the second flow channel 32a2 on the front side F are connected to each other.

Note that, as indicated by a dotted line in FIG. 3, a width w3 of the internal space 32a (the first flow channel 32al and the second flow channel 32a2) is substantially equal to a width w2 of the nozzle 36 to be described below. Specifically, when the width w2 of the nozzle 36 is 100%, the width w3 of the internal space 32a is preferably 80% to 120%, more preferably 90% to 110%, and particularly preferably 95% to 105%. Thus, the inert gas G can be supplied homogeneously to the entire nozzle 36 in the width direction X, thereby making it possible to suppress the occurrence of the turbulent flow in the inert gas G jetted from the nozzle 36.

### (2) Supply Pipe 34

The supply pipe 34 is a pipe that supplies the inert gas G to the internal space 32a of the chamber 32. The supply pipe 34 illustrated in FIG. 2 connects between the chamber 32 and a gas supply source 39. Specifically, one end part 34a of the supply pipe 34 is connected to an end part of the first flow channel 32al of the chamber 32 on a lower side D (see FIG. 4). In addition, the other end part 34b of the supply pipe 34 is connected to the gas supply source 39 (see FIG. 2). Note that the supply pipe 34 in this embodiment is branched to a plurality of (in FIG. 2, four) pipes before being connected to the chamber 32. Then, the one end parts 34a of the plurality of supply pipes 34 after the branching are disposed with a predetermined gap therebetween in the width direction X. Thus, the flow amount of the inert gas G supplied to the internal space 32a of the chamber 32 is diffused in the width direction X, thereby making it possible to suppress the variation in flow rate in the width direction X. To the respective supply pipes 34, valves V1 to V4 are attached. Each of the valves V1 to V4 is configured to be opened and closed independently by a control device (the illustration is omitted). Thus, the supply amount of the inert gas G in the width direction X can be adjusted more precisely.

Note that the inert gas G supplied from the gas supply source 39 is not limited in particular and the conventionally known gas that can be used for preventing the oxidation of metals can be widely used. For example, the inert gas G may be a nitrogen gas, an argon gas, a carbon dioxide gas, or the like. In addition, the inert gas G may be a mixture of a plurality of kinds of gases.

### (3) Nozzle 36

The nozzle 36 is an opening part communicating with the supply pipe 34 through the internal space 32a. As illustrated in FIG. 4, the nozzle 36 in this embodiment is formed at a terminal end of the internal space 32a of the chamber 32 (at an end part of the second flow channel 32a2 on a rear side Rr). Thus, the inert gas G supplied from the supply pipe 34 is jetted from the nozzle 36 through the internal space 32a of the chamber 32. In addition, the nozzle 36 is provided at a position adjacent to the upper end (the sealing plate 130) of the case main body 120. Thus, the inert gas G jetted from the nozzle 36 is supplied suitably to the laser irradiation region A.

As illustrated in FIG. 2 and FIG. 3, the nozzle 36 in this embodiment is the slit-shaped opening part extending along one side of the laser irradiation region A. By jetting the inert gas G from the wide nozzle 36 to the laser irradiation region A, the inert gas G can be supplied homogeneously to the entire range of the laser irradiation region A in the extending direction. Specifically, the nozzle 36 in this embodiment extends along the first region A1 of the laser irradiation region A. Jetting the inert gas G from the nozzle 36 extending along the first region A1, which is the relatively long laser irradiation region A, makes it possible to homogeneously decrease the oxygen concentration in the entire laser irradiation region A in the width direction X. However, providing such a wide nozzle 36 easily causes a variation in flow rate of the inert gas G in the extending direction of the nozzle 36 (the width direction X). The welding device 1 according to this embodiment is configured to be able to suppress the variation in flow rate of the inert gas G even when the wide nozzle 36 is provided, which will be described in detail below.

Note that as indicated by the dotted line in FIG. 3, the width w2 of the nozzle 36 is preferably more than or equal to a width w1 of one side (here, the first region A1) of the opposing laser irradiation region A. Specifically, when the width w1 of the first region A1 is 100%, the width w2 of the nozzle 36 is preferably 100% to 130% and more preferably 100% to 120%. For example, when the width w1 of the first region A1 is 100%, the width w2 of the nozzle 36 is particularly preferably 108% or more. Thus, the inert gas G can be supplied to the entire laser irradiation region A in a longitudinal direction, thereby making it possible to reduce the oxygen concentration around the laser irradiation region A more suitably. However, when the width w2 of the nozzle 36 becomes too long, the flow rate in the width direction X tends to vary. For example, in the case where the width of the nozzle 36 is 100 mm or more (particular, 120 mm or more), the flow rate in the width direction X tends to vary in particular. The welding device 1 according to this embodiment, however, is configured to be able to suppress the variation in flow rate of the inert gas G even when such a wide nozzle 36 is provided.

### (4) Rectifying Member 38

The rectifying member 38 is a porous body that is accommodated in the internal space 32a to partition between the supply pipe 34 and the nozzle 36. This rectifying member 38 can solve the variation in flow rate of the inert gas G in the width direction X and prevent the occurrence of the turbulent flow in the inert gas G after the jetting. Specific description will be made below.

First, as illustrated in FIG. 4, the inert gas G supplied from the supply pipe 34 is jetted from the nozzle 36 through the internal space 32a of the chamber 32. At this time, in the internal space 32a of the chamber 32, the flow rate of the inert gas G becomes fast at a position that is close to the supply pipe 34 and the flow rate of the inert gas G becomes slow at a position that is far from the supply pipe 34. This may result in the variation in flow rate in the width direction X concerning inert gases G1 to G5 (see FIG. 3) supplied from the internal space 32a to the nozzle 36. Jetting the inert gas G from the nozzle 36 with the flow rate varied in the width direction X causes the turbulent flow in the space on the upper side U of the laser irradiation region A. In this case, the ambient air is caught in the inert gas G, which may result in that the oxygen concentration around the laser irradiation region A does not decrease sufficiently. In contrast to this, the internal space 32a of the welding device 1 according to this embodiment accommodates the rectifying member 38 to partition between the supply pipe 34 and the nozzle 36. Thus, the inert gas G before being supplied to the nozzle 36 passes the rectifying member 38. Accordingly, the variation in flow rate of the inert gas G in the extending direction of the nozzle 36 (the width direction X) is solved, so that the occurrence of the turbulent flow in the inert gas G after the jetting can be prevented. As a result, the oxygen concentration around the laser irradiation region A can be reduced sufficiently, thereby making it possible to form the welding part of the high quality in which the oxidation is suppressed.

Note that the rectifying member 38 in this embodiment is a mesh sheet 38a. This mesh sheet 38a fills the entire internal space 32a in the width direction X. Thus, the inert gas G before being supplied to the nozzle 36 passes the rectifying member 38 at least once; therefore, the variation in flow rate of the inert gas G in the width direction X can be prevented suitably. Note that “the mesh sheet 38a fills the entire internal space 32a in the width direction X” here refers to that when the width of the internal space 32a is 100%, 90% to 100% (preferably 95% to 100% and more preferably 99% to 100%) of the internal space 32a is filled with the mesh sheet 38a.

In addition, as illustrated in FIG. 4, the rectifying member 38 according to this embodiment is a wound body of the mesh sheet 38a. Thus, the inert gas G before being supplied to the nozzle 36 passes the rectifying member 38 a plurality of times, thereby making it possible to solve the variation in flow rate of the inert gas G more suitably. Note that the number of times of winding the mesh sheet 38a may be two or more (preferably three or more and more preferably four or more). As the number of times of winding the mesh sheet 38a increases, the variation in flow rate of the inert gas G is solved more easily. On the other hand, the upper limit of the number of times of winding the mesh sheet 38a is not limited in particular and may be ten or less, eight or less, or six or less.

### C. Manufacturing Method for Electrical Energy Storage Device

Next, a manufacturing method for the electrical energy storage device using the welding device 1 with the aforementioned structure (hereinafter also referred to as “manufacturing method” simply) is described. The manufacturing method according to this embodiment is a method for manufacturing the electrical energy storage device 100 including the case main body 120 with the substantially cuboid shape including the opening part on one surface, and the sealing plate 130 with the substantially rectangular shape that closes the opening part of the case main body 120. This manufacturing method includes an assembling step and a welding step.

### 1. Assembling Step

FIG. 5 is a perspective view schematically illustrating the assembling step of the manufacturing method according to the first embodiment. In this assembling step, the sealing plate 130 is mounted on the opening part 128 of the case main body 120. In this step, first, the sealing plate 130 including the positive electrode terminal 140 and the negative electrode terminal 150 is prepared. Then, the positive electrode terminal 140 and the negative electrode terminal 150 are connected to the electrode body 180. Thus, the sealing plate 130 and the electrode body 180 are integrated. In this state, the electrode body 180 is inserted to the inside of the case main body 120 through the opening part 128. Then, the sealing plate 130 and the electrode body 180 are lowered further. Thus, the sealing plate 130 is mounted on the opening part 128 of the case main body 120.

### 2. Welding Step

In the welding step, while the inert gas G is supplied toward the laser irradiation region A, which is the boundary between the case main body 120 and the sealing plate 130, the laser L travels along the laser irradiation region A. In this step, first, the case main body 120 is disposed between the first clamps 12 and the second clamps 14 of the positioning part 10. Then, the case main body 120 is held by the first clamps 12 and the second clamps 14. Thus, the case main body 120 is fixed. Next, the inert gas G is jetted from the nozzle 36 of the inert gas supply part 30. Thus, the oxygen concentration around the laser irradiation region A decreases. The welding device 1 then irradiates the laser irradiation region A with the laser L from the laser irradiation part 20. Thus, the case main body 120 and the sealing plate 130 are welded together. At this time, since the oxygen concentration around the laser irradiation region A decreases, the oxidation of the welding part after the laser irradiation can be prevented.

Here, in the welding step in this embodiment, the inert gas G is supplied from the slit-shaped nozzle 36 extending along at least one side (first region A1) of the laser irradiation region A and the inert gas G before being supplied to the nozzle 36 passes the rectifying member 38, which is the porous body. Thus, the inert gas G whose variation in flow rate has been solved can be jetted to the entire range of the laser irradiation region A in the extending direction (width direction X); therefore, the increase in oxygen concentration due to the air being caught can be prevented.

Note that, in the welding step in this embodiment, the oxygen concentration around the laser irradiation region A is preferably controlled to be 1.5% or less. Thus, the oxidation of the welding part after the laser irradiation can be prevented more certainly. Note that the oxygen concentration around the laser irradiation region A can be controlled by adjusting the supply amount of the inert gas G from the gas supply source 39. In particular, in the welding device 1 according to this embodiment, the variation in flow rate of the inert gas G in the width direction X can be solved as described above. Thus, even if the supply amount of the inert gas G from the gas supply source 39 is increased, the air being caught by the turbulent flow can be prevented.

### Other Embodiments

The first embodiment of the art disclosed herein has been described above. The art disclosed herein, however, is not limited to the first embodiment described above and various structures can be changed as appropriate. Other embodiments of the art disclosed herein will be described below.

### 1. Structure of Rectifying Member

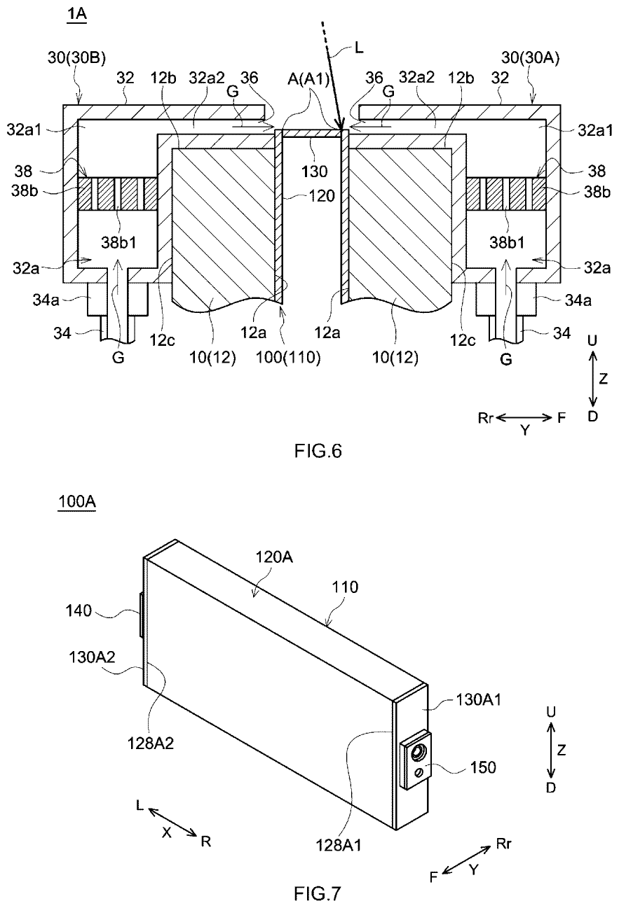

As described above, the welding device 1 according to the first embodiment includes the wound body of the mesh sheet 38a as the rectifying member 38. However, the rectifying member may be any porous body that partitions between the supply pipe and the nozzle without being limited to the wound body of the mesh sheet. For example, a welding device 1A illustrated in FIG. 6 includes, as the rectifying member 38, a punching plate 38b including a penetration hole 38b1 through which the inert gas G passes. This punching plate 38b is disposed so as to cross the flow channel of the inert gas G from the supply pipe 34 to the nozzle 36. Specifically, the punching plate 38b is disposed in the entire range of the internal space 32a of the chamber 32 in the width direction (direction perpendicular to a paper surface in FIG. 6). Thus, the inert gas G before being supplied to the nozzle 36 can pass the punching plate 38b. Even in the case of using such a rectifying member 38, the variation in flow rate of the inert gas G in the width direction X can be solved. In addition, the rectifying member can employ another structure. For example, the rectifying member may be a mesh sheet multilayer body. This mesh sheet multilayer body may be formed by folding one mesh sheet or overlapping a plurality of mesh sheets. Alternatively, the rectifying member can use a sponge, a ceramic porous body, or the like.

### 2. Structure of Inert Gas Supply Part

As illustrated in FIG. 2 to FIG. 4, the pair of inert gas supply parts 30A and 30B are disposed to have the electrical energy storage device 100 therebetween in the depth direction Y in the welding device 1 according to the first embodiment. The welding device, however, only needs to include at least one inert gas supply part. For example, only one of the inert gas supply part 30A on the front side F and the inert gas supply part 30B on the rear side Rr illustrated in FIG. 2 may be disposed. Furthermore, the welding device 1 according to the first embodiment includes the inert gas supply part 30 attached to each of the pair of first clamps 12. In addition, the inert gas supply part may be attached to each of the second clamps 14. In this case, the inert gas can be supplied from all around (four directions) the electrical energy storage device 100. However, it is preferable to dispose the pair of inert gas supply parts 30A and 30B in the depth direction Y as described in the first embodiment. This makes it possible to dispose the nozzle 36 extending along the long first region A1, thereby preventing the occurrence of the turbulent flow more suitably.

Moreover, as illustrated in FIG. 3, the plurality of (four) supply pipes 34 are connected with a predetermined gap therebetween in the width direction X to the chamber 32 in the welding device 1 according to the first embodiment. The number of supply pipes to be connected to the chamber, however, is not limited in particular. For example, the number of supply pipes may be one or more, and is preferably two or more and more preferably three or more. Using more supply pipes makes it possible to suppress the variation in flow rate of the inert gas G in the width direction X. However, from the viewpoints of the component cost and the device control, the number of supply pipes is preferably ten or less, more preferably eight or less, and particularly preferably six or less.

### 3. Manufacture Target

As illustrated in FIG. 1, the electrical energy storage device 100 including the case main body 120 with the opening part 128 on the upper surface, and one sealing plate 130 that closes the opening part 128 on the upper surface is manufactured in the first embodiment. The art disclosed herein, however, is widely applicable to the manufacture of the electrical energy storage device including the case main body and the sealing plate, and is not limited to the manufacture of the electrical energy storage device 100 illustrated in FIG. 1. For example, an electrical energy storage device 100A illustrated in FIG. 7 includes a case main body 120A including a pair of opening parts 128A1 and 128A2 on both side surfaces in the width direction X, and two sealing plates 130A1 and 130A2 that close the pair of opening parts 128A1 and 128A2. In the electrical energy storage device 100A with such a structure, the case main body 120A and the sealing plates 130A1 and 130A2 are welded to each other on a right side R and a left side L in the width direction X, respectively. The art disclosed herein is also applicable to the manufacture of the electrical energy storage device 100A with such a structure.

### TEST EXAMPLES

Text Examples related to the art disclosed herein will hereinafter be described. The description of Test Examples, however, will not limit the art disclosed herein to the following tests.

### 1. Preparation of Samples

In this test, three kinds of welding devices (Test Examples 1 to 3) including the inert gas supply parts with different structures were prepared, and the sealing plate and the case main body were subjected to the laser welding while the inert gas was jetted to the laser welding region. The detailed conditions are shown below.

### (1) Test Example 1

First, in this test, the case main body whose opening part had a size of 120 mm×13 mm was prepared and the sealing plate (119 mm×12 mm) was mounted on the opening part. Then, the case main body was attached to the welding device 1 with the structure illustrated in FIG. 2 and FIG. 3. Subsequently, the inert gas G was supplied from the gas supply source 39 to the chamber 32. In this test, the nitrogen gas with a flow amount of 60 L/min was supplied as the inert gas G to the inside of the chamber 32. Then, in Test Example 1, the wound body (rectifying member 38) in which the mesh sheet 38a with a mesh diameter of 0.13 mm was wound twice was accommodated in the internal space 32a of the chamber 32. Subsequently, the laser welding was performed while the nitrogen gas having passed this rectifying member 38 was jetted from the slit-shaped nozzle 36 extending along the first region A1. The laser welding here used a fiber laser (output: 2 kW, travel speed: 200 mm/min).

### (2) Test Example 2

In Test Example 2, the welding device not including the internal space for accommodating the rectifying member and including the internal flow channel with substantially the same width as the slit-shaped nozzle was used. Note that the other conditions were the same as those in Test Example 1.

### (3) Test Example 3

In Test Example 3, the case main body and the sealing plate were welded under the same conditions as those in Test Example 1 except that the nozzle was changed to a nozzle whose opening part had the different shape. Specifically, in Test Example 3, a nozzle with 22 circular opening parts with a diameter of 1 mm was used. Note that the circular opening parts were formed at equal intervals along the width direction X.

### 2. Evaluation Test

### (1) Measurement of Oxygen Concentration

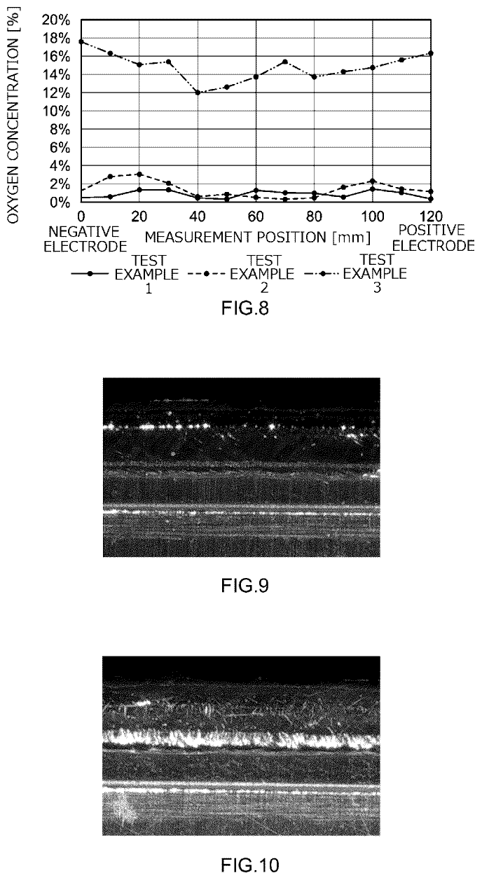

In this test, the oxygen concentration around the laser welding region was measured. Specifically, the space over the laser welding region was sucked with the nitrogen gas jetted from the nozzle of the welding device. Then, the oxygen concentration of the collected gas was measured using an oxygen concentration metering machine manufactured by Yokogawa Electric Corporation (model: OX-400). Note that the tube used to collect the gas had a diameter of 2.5 mm and the suction flow amount was set to 200 mL/min. In addition, in this test, the gas was collected at an interval of 10 mm in the width direction X, and the oxygen concentration at each of 13 measurement points was measured. The oxygen concentration at each measurement point is shown in FIG. 8. The average value, the maximum value, the minimum value, and the difference between the maximum value and the minimum value of the oxygen concentration are shown in Table 1.

### (2) Evaluation of Welding Quality

In this test, the quality of the welding part after the laser irradiation was checked visually. Specifically, if the oxidation occurs in the laser irradiation, the welding part with a crease is formed. The photograph of the welding part in Test Example 1 is shown in FIG. 9 and the photograph of the welding part in Test Example 2 is shown in FIG. 10.

TABLE 1

| | Manufacturing conditions | | Oxygen concentration (%) | | | |
|---|---|---|---|---|---|---|
| | Nozzle | Rectifying | Average | Maximum | Minimum | Maximum value − |
| | shape | member | value | value | value | minimum value |
| Test Example 1 | Slit | Present | 0.9 | 1.5 | 0.3 | 1.2 |
| Test Example 2 | Slit | Absent | 1.5 | 3.1 | 0.4 | 2.7 |
| Test Example 3 | Multiple | Absent | 14.5 | 17.9 | 11.4 | 6.5 |
| | openings | | | | | |

As shown in FIG. 8 and Table 1, it has been confirmed that the oxygen concentration around the laser welding region remarkably decreased in Test Example 1 compared to Test Examples 2 and 3. In Test Example 1, in particular, the variation in oxygen concentration in the width direction was very small. Moreover, as shown in FIG. 9, FIG. 10, and Table 1, the generation of the crease due to the oxidation of the welding part was remarkably suppressed in Test Example 1. This indicates that, when the inert gas having passed the rectifying member is jetted from the slit-shaped nozzle, the air will not be caught, so that the oxygen concentration in the welding can be largely reduced. In addition, it has been understood that performing the laser welding in such a low oxygen environment can form the welding part of the high quality in which the oxidation is suppressed.

The specific examples of the art disclosed herein has been described above; however, these are just examples and will not limit the scope of claims. The art described in the scope of claims includes those in which the specific examples given above are variously modified and changed. For example, the art disclosed herein includes aspects according to the following Items.

### <Item 1>

A welding device used to weld a case main body with an substantially cuboid shape that includes an opening part on at least one surface, and a sealing plate with an substantially rectangular shape that closes the opening part,
the welding device comprising:
a laser irradiation part that causes laser to travel along a laser irradiation region corresponding to a boundary between the case main body and the sealing plate; and
an inert gas supply part that supplies an inert gas toward the laser irradiation region, wherein
the inert gas supply part includes:
   a chamber that includes an internal space,
   a supply pipe that supplies the inert gas to the internal space of the chamber,
   a slit-shaped nozzle communicating with the supply pipe through the internal space and extending along at least one side of the laser irradiation region, and
   a rectifying member being a porous body that is accommodated in the internal space to partition between the supply pipe and the nozzle.

### <Item 2>

The welding device according to Item 1, in which the rectifying member is the mesh sheet.

### <Item 3>

The welding device according to Item 2, in which the rectifying member is the wound body or the multilayer body of the mesh sheet.

### <Item 4>

The welding device according to Item 1, in which the rectifying member is the punching plate including the penetration hole through which the inert gas passes.

### <Item 5>

The welding device according to any one of Items 1 to 4, in which the laser irradiation region includes the first region extending in the long side direction of the case main body, and the nozzle extends along the first region.

### <Item 6>

The welding device according to any one of Items 1 to 5, further including the positioning part that fixes the case main body, in which the inert gas supply part is attached to the positioning part.

### <Item 7>

The welding device according to any one of Items 1 to 6, in which the nozzle has a length of 100 mm or more.

### <Item 8

A manufacturing method for an electrical energy storage device including a case main body with an substantially cuboid shape that includes an opening part on at least one surface, and a sealing plate with an substantially rectangular shape that closes the opening part, the manufacturing method comprising:
an assembling step of mounting the sealing plate on the opening part of the case main body; and
a welding step of causing laser to travel along a laser irradiation region corresponding to a boundary between the case main body and the sealing plate while supplying an inert gas toward the laser irradiation region, wherein in the welding step, the inert gas is supplied from a slit-shaped nozzle extending along at least one side of the laser irradiation region and the inert gas before being supplied to the nozzle passes a rectifying member being a porous body.

### <Item 9>

The manufacturing method for the electrical energy storage device according to Item 8, in which the oxygen concentration around the laser irradiation region in the welding step is controlled to be 2% or less.

What is claimed is:

1. A welding device used to weld a case main body with an substantially cuboid shape that includes an opening part on at least one surface, and a sealing plate with an substantially rectangular shape that closes the opening part,
the welding device comprising:
a laser irradiation part that causes laser to travel along a laser irradiation region corresponding to a boundary between the case main body and the sealing plate; and
an inert gas supply part that supplies an inert gas toward the laser irradiation region, wherein
the inert gas supply part includes:
a chamber that includes an internal space,
a supply pipe that supplies the inert gas to the internal space of the chamber,
a slit-shaped nozzle communicating with the supply pipe through the internal space and extending along at least one side of the laser irradiation region, and
a rectifying member being a porous body that is accommodated in the internal space to partition between the supply pipe and the nozzle.

2. The welding device according to claim 1, wherein the rectifying member is a mesh sheet.

3. The welding device according to claim 2, wherein the rectifying member is a wound body or a multilayer body of the mesh sheet.

4. The welding device according to claim 1, wherein the rectifying member is a punching plate including a penetration hole through which the inert gas passes.

5. The welding device according to claim 1, wherein
the laser irradiation region includes a first region extending in a long side direction of the case main body, and
the nozzle extends along the first region.

6. The welding device according to claim 1, further comprising a positioning part that fixes the case main body, wherein the inert gas supply part is attached to the positioning part.

7. The welding device according to claim 1, wherein the nozzle has a length of 100 mm or more.

8. A manufacturing method for an electrical energy storage device including a case main body with an substantially cuboid shape that includes an opening part on at least one surface, and a sealing plate with an substantially rectangular shape that closes the opening part, the manufacturing method comprising:
an assembling step of mounting the sealing plate on the opening part of the case main body; and
a welding step of causing laser to travel along a laser irradiation region corresponding to a boundary between the case main body and the sealing plate while supplying an inert gas toward the laser irradiation region, wherein in the welding step, the inert gas is supplied from a slit-shaped nozzle extending along at least one side of the laser irradiation region and the inert gas before being supplied to the nozzle passes a rectifying member being a porous body.

9. The manufacturing method for an electrical energy storage device according to claim 8, wherein an oxygen concentration around the laser irradiation region in the welding step is controlled to be 2% or less.
